(19) United States
(12) Patent Application Publication
(10) Pub. No.: US 2008/0184563 A1
(43) Pub. Date: Aug. 7, 2008

(54) Dual directional razor

(76) Inventor: Wasiem Hamadeh, Redmond, WA (US)

Correspondence Address: DEAN A. CRAINE, Suite 140, 400 - 112th Avenue NE, BELLEVUE, WA, 98004, US

(21) Appl. No.: 12/012,259

(22) Filed: Feb. 1, 2008

Related U.S. Application Data
(60) Provisional application No. 60/899,204, filed on Feb. 1, 2007.

(51) Int. Cl. B26B 19/38; B26B 21/00; B26B 21/52

(52) U.S. Cl. 30/41; 30/50; 30/527; 30/526

(57) ABSTRACT

A dual directional disposable razor that includes a razor head with two sets of inward slanted blades mounted transversely therein. The cutting tips of the blades extend through an opening formed on the top surface of the razor head. The razor head is pivotally mounted on the distal end of a handle which allows the razor head to maintain contact with the skin at all times and yet allow the handle to be rotated above or below the razor head. In the preferred embodiment, the top surface of razor head and the longitudinal axis of the handle are approximately 20 degrees apart. The two sets of blades are equally aligned on opposite sides of the head's center longitudinal axis and stop surfaces are provided between the head and the handle so that the blades are properly positioned. An optional flexible swipe blade is attached to the upper back edge of the razor head that allows the user to wipe away excess shaving cream or gel.

This is a utility patent application which claims benefit of U.S. Provisional Application No. 60/899,204 filed on Feb. 1, 2007.

### BACKGROUND OF THE INVENTION

1. Field of the Invention

This invention pertains to disposable razors, and more particularly to disposable razors designed to safely cut whiskers or hairs on the skin when moving the razor head back and forth over the skin in opposite direction.

2. Description of the Related Art

Disposable razors are very popular because they are relatively inexpensive and provide a reasonably close shave. Typically, disposable razors include two to five parallel blades mounted longitudinally inside the razor head. All of the blades are diagonally aligned in the same direction so that the blade's cutting edges and cuts whiskers or hairs when the razor head is pulled over the skin.

The razor head is perpendicularly aligned on the distal end of a rigid handle. On some razors, the razor head is able to rotate 20 to 30 degrees over the end of the handle allowing it to swivel and closely conform to the skin.

One drawback with using disposable razors is that the razor head must be lifted and re-positioned on the skin at the end of each stroke. If the razor head is lifted and not re-positioned properly on the skin, the blades may cut the skin. Re-positioning the razor head properly on the skin to prevent cuts is especially problematic for men when shaving around the chin and jaw and for woman when shaving their legs.

It is well known that facial whiskers and leg hair grows at different angles and that moving the razor head back and forth in different directions over the skin provides a closer shave than does moving the razor in one direction. Unfortunately, in order to move typical razors back and forth over the skin, the razor head must be lifted and re-positioned on the skin, thus increasing the opportunities for cuts.

What is needed is a disposable razor that enables the razor head to be moved back and forth over the skin for a closer shave that does not require the head to be lifted and re-positioned on the skin.

### SUMMARY OF THE INVENTION

The above objects are met by the disposable razor disclosed herein that includes a razor head with two sets of inward, opposite slanted blades mounted transversely therein. The cutting edges of the blades extend through an opening formed on the front surface of the razor head. The razor head is pivotally mounted on the distal end of a handle which allows the razor head to swivel over the skin while maintaining contact with the skin as the handle is rotated above or below the razor head. By merely rotating the handle over the razor head, the razor can be used in a back and forth motions over the skin forcing a close shave. In the preferred embodiment, the front surface of the razor head and the longitudinal axis of the handle are approximately 20 degrees apart. In one embodiment, the handle is able to rotate approximately 20 to 140 degrees over the back surface of the razor head. In another embodiment, the handle is fixed on the razor head. Each set of blades includes 2 to 4 individual blades. The blades in each set are spaced apart approximately 1/64 of inch and are diagonally aligned approximately 45 degrees from the razor head's front surface. The two sets of blades are equally aligned on opposite sides of the head's center longitudinal axis. Stop surfaces are provided between the head and the handle so that the blades are properly positioned for cutting when the handle is rotated to a full downward or upward position.

An optional flexible swipe blade is attached to the upper back edge of the razor head that allows the user to wipe away excess shaving cream or gel from the skin.

### DESCRIPTION OF THE DRAWINGS

FIG. 1 is a perspective view of the dual directional razor.

FIG. 2 is a partial side elevational view of the razor head with the handle rotated downward and the razor head being aligned so that the top set of blades are used for shaving.

FIG. 3 is a partial side elevational view of the razor head with the handle rotated upward and the razor head being aligned so that the bottom set of blades are used for shaving.

FIG. 4 is a front elevational view of the razor head.

FIG. 5 is a rear elevational view of the razor head.

FIG. 6 is a front view of another embodiment of the razor with two slide plates mounted on the razor head's front surface.

FIG. 7 is a side elevational view of the razor shown in FIG. 6 showing the swiveling movement of the razor head on the end of the handle.

FIG. 8 is a sectional side elevational view of the razor head shown along line 8-8 in FIG. 6.

FIG. 9 is a perspective view of a blade used in the razor head shown in FIGS. 6-8.

### DESCRIPTION OF THE PREFERRED EMBODIMENT(S)

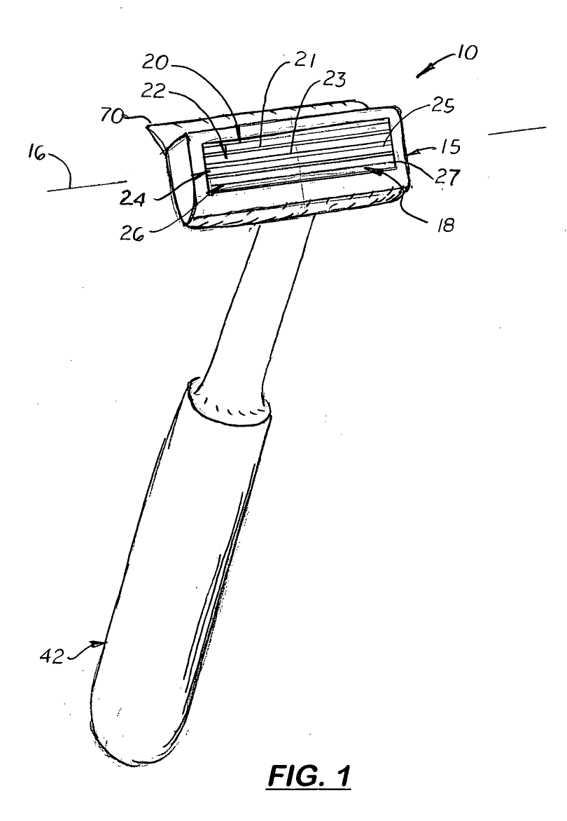

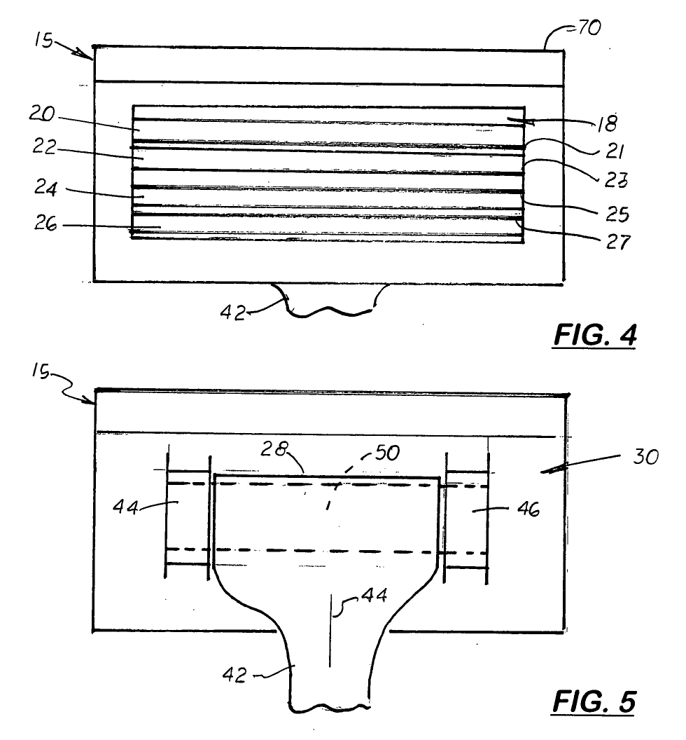

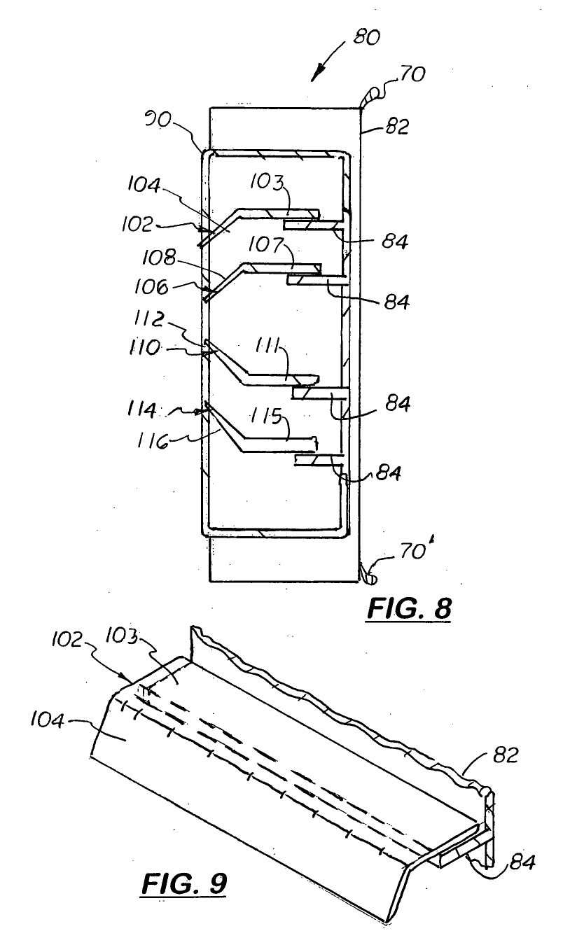

Referring to the accompanying FIGS. 1-9, there is shown and described a disposable razor, generally indicated by the reference number 10 that includes a razor head 15 pivotally attached to a handle 42. The razor head 15 is rectangular and includes a front opening 18 with two sets of inward slanted parallel blades, two top blades 20, 22 and two bottom blades 24, 26. The two sets of blades 20, 22 and 24, 26 are mounted parallel with the head's longitudinal axis 16. The cutting tips 21, 23, 25, 27 of the blades 20, 22, 24, 26, respectively, extend through the front opening 18 and press against the user's skin 90. The razor head 15 is held at a desired angle 90 against the skin when shaving.

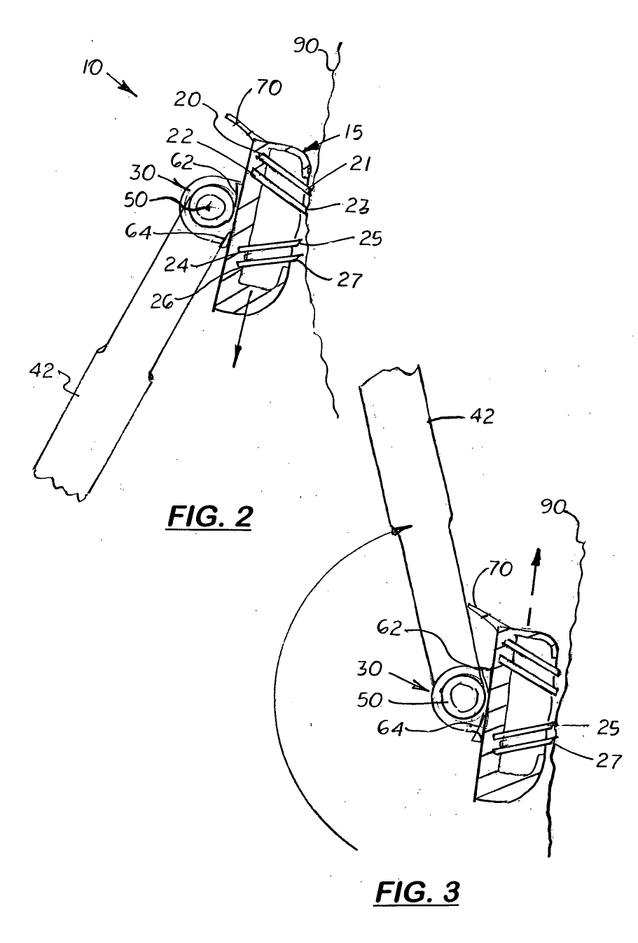

Disposed between the razor head 15 and the handle 42 is a joint 30 that allows the handle 42 to rotate between a downward diagonal position shown in FIG. 2 and an upward diagonal position shown in FIG. 3. In the preferred embodiment, the joint 30 includes two diagonal arms 44 and 46 mounted or formed on the back surface of the razor head 15. The two arms 44, 46 are spaced apart and designed to receive the bushing 28 mounted or formed on the top of the handle 42. The bushing 28 and two arms 44, 46 include bores (not shown) through which an axle 50 is extended to pivotally attach the razor head 15 and handle 42 together. The razor head 15 is able to rotated approximately 15 degrees over the ends of the two arms 44, 46.

In the first embodiment, the two sets of blades 20, 22 and 24, 26 are equally aligned on opposite sides of the head's 15 center longitudinal axis 16. Stop surfaces 62, 64 are provided between the head 15 and the bushing 50 so that the blades 20, 22 and 24, 26 are properly positioned when pulling the handle 42 in opposite directions over the skin 90.

An optional flexible swipe blade 70 is attached to the upper back edge of the razor head 15 that allows the user to wipe away excess shaving cream or gel.

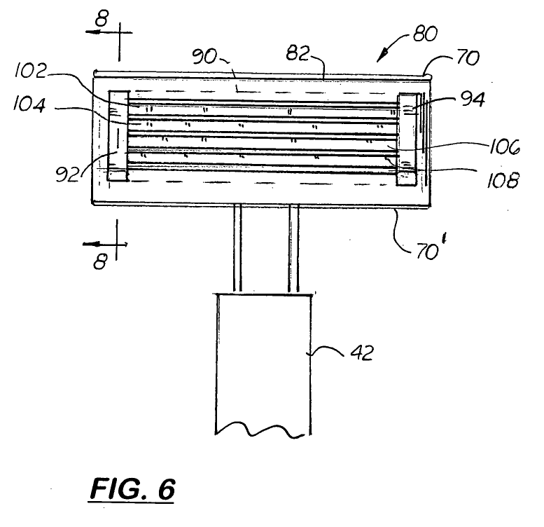

FIGS. 6-9, show another embodiment of the razor head, indicated by the reference number 80. The razor head 80 includes two sets of diagonally aligned blades 102, 106, 110, 114 held in position by a rectangular frame 90. The frame 90 includes two vertical side plates 92, 94 that extending over the front surface of the razor head body 82. The side plates 92, 94 extend slightly beyond the front surface of the body 82 and act as a skin support surface when shaving. Each blade 102, 106, 110, 114 is an angled structure with a rear straight section 103, 107, 111, 115 and a front angled straight section 104, 108,112 116, respectively. Mounted on the back of the body 82 are forward extending supports 84 over which the rear straight sections 103, 107, 111, 115 extends. The rear straight sections 103, 107, 111, 115 are welded or glued onto the supports 84 to hold the blades in place.

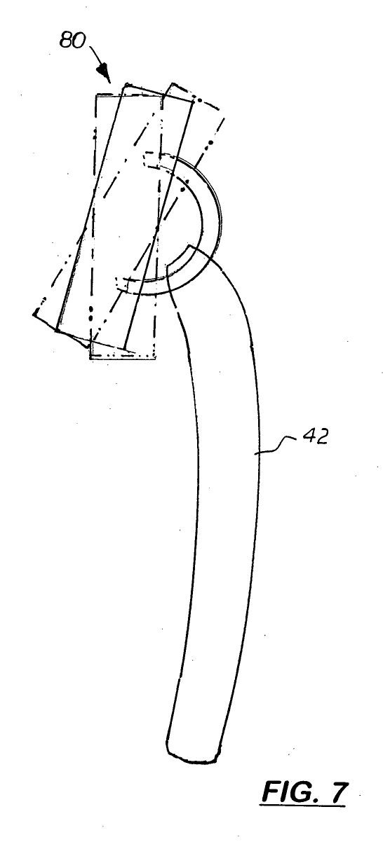

As shown in FIG. 7, the razor head on the second embodiment is designed to swivel approximately 15 to 20 degrees from its transverse axis. An optional swipe plate 70 or 70′ may be attached either to the top or bottom edge of the razor head or to both edges.

In both embodiments, each set of blades includes 2 to 4 individual blades. The blades in each set are spaced apart approximately 1/64 of inch and are diagonally aligned approximately 45 degrees from the razor head's front surface

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A disposable dual directional razor, comprising:
a. a razor head with two sets of inward slanted blades mounted transversely therein, each said blade includes a cutting tip that extends through an opening formed on the top surface of the razor head; and,
b. a handle.

2. The razor, as described in claim 1, further including means for rotating said handle over said razor head.

3. The razor, as shown in claim 2, further including a swipe blade attached to the razor head to remove excess shaving cream from the user's face.

4. The razor, as shown in claim 1, further including a swipe blade attached to the razor head to remove excess shaving cream from the user's face.

5. The razor, as recited in claim 1, wherein said razor head includes two side plates that extend from the front surface of said razor head and support said razor head against the skin when shaving.

6. The razor, as recited in claim 3, wherein said razor head includes two side plates that extend from the front surface of said razor head and support said razor head against the skin when shaving.

7. The razor, as recited in claim 1, wherein each said razor includes a straight rear section and a bent front section, said rear section being supported by said razor head.

8. The razor, as recited in claim 7, wherein each said razor includes a straight rear section and a bent front section, said rear section being supported by said razor head.
